(19) United States
(12) Patent Application Publication
(10) Pub. No.: US 2025/0044593 A1
(43) Pub. Date: Feb. 6, 2025

(54) MIXED REALITY DEVICE

(71) Applicant: GUANGZHOU LUXVISIONS INNOVATION TECHNOLOGY LIMITED, GUANGZHOU (CN)

(72) Inventors: Guan-Yang Liu, GUANGZHOU (CN); Chuan-Hui Liu, GUANGZHOU (CN); Che-Kai Chang, GUANGZHOU (CN)

(73) Assignee: GUANGZHOU LUXVISIONS INNOVATION TECHNOLOGY LIMITED, GUANGZHOU (CN)

(21) Appl. No.: 18/642,826

(22) Filed: Apr. 23, 2024

(30) Foreign Application Priority Data
Aug. 2, 2023 (CN) 202310966284.9

(51) Int. Cl. G02B 27/01; G02B 25/00

(52) U.S. Cl. CPC G02B 27/0172; G02B 25/001; G02B 27/0179; G02B 2027/0187

(57) ABSTRACT

Provided is a mixed reality device including a Fourier 4F optical architecture and a design of folding a light path to display images of different depths. In addition to achieving real-time multi-depth and mixed reality display effects, it may also have a wide field of view and effectively avoid a vergence-accommodation conflict.

### CROSS-REFERENCE TO RELATED APPLICATION

This application claims the priority benefit of China application serial no. 202310966284.9, filed on Aug. 2, 2023. The entirety of the above-mentioned patent application is hereby incorporated by reference herein and made a part of this specification.

### BACKGROUND

### Technical Field

The disclosure relates to a mixed reality device.

### Description of Related Art

Mixed reality (MR) is a technology that combines virtual reality (VR) and augmented reality (AR), which may break the barrier between virtuality and reality, integrate a real environment into a virtual world, and allow users to interact with real and virtual objects at the same time. When the users watch mixed reality images through near-eye display devices, display requirements such as high image quality, high pixel density, high refresh rate, and wide field of view are required to provide the users with a better wearing experience.

In addition, stereoscopic vision of eyes of a human is mainly accomplished through two main parts, namely vergence and accommodation. “Vergence” allows the eyes to look at a single object from different angles on both sides to form the stereoscopic vision in a brain. “Accommodation” is to change curvature of a lens through muscles around the eyes to adjust a focal point and see objects at different distances clearly. When landscapes at different distances are presented on a display screen at the same focal length, it will cause a vergence-accommodation conflict (VAC), which significantly reduces wearing comfort, indirectly reduces the time of wearing such head mounted devices, and limits application fields thereof.

Therefore, how to develop an MR device that both “meets the stringent display requirements for near-eye devices” and “overcome VAC” has become an urgent issue that is required to be solved.

### SUMMARY

The disclosure provides a mixed reality device that may provide display images with both different depths and multiple focal points and effectively avoid VAC.

According to an embodiment of the disclosure, a mixed reality device is provided, including an image system. The image system includes a first image source, a second image source, a beam splitter, a first lens set, and a second lens. The first image source is configured to provide a first image beam. The second image source is configured to provide a second image beam. The beam splitter is disposed on paths of the first image beam and the second image beam. The first lens set is disposed between the second image source and the beam splitter and includes at least one lens element. The second lens set is disposed on the paths of the first image beam and the second image beam and includes multiple lens elements. The first image beam and the second image beam are imaged on an eye box of the mixed reality device after moving backward and forward between the lens elements of the second lens set, and a field of view after the first image beam and the second image beam exit the second lens set is greater than a field of view before the first image beam and the second image beam enter the second lens set.

Based on the above, in the mixed reality device provided according to the embodiments of the disclosure, through the optical architectures with different focal lengths, the images of different depths are converged on the eye box at the same time, providing an effect of stereoscopic vision, effectively avoiding VAC, and providing the user with a comfortable wearing experience.

In order for the aforementioned features and advantages of the disclosure to be more comprehensible, embodiments accompanied with drawings are described in detail below.

### BRIEF DESCRIPTION OF THE DRAWINGS

FIG. 1A is a schematic diagram of a mixed reality device according to an embodiment of the disclosure.

FIG. 1B is a schematic diagram of an image system according to an embodiment of the disclosure.

FIG. 2 is a schematic diagram of folding a light path according to an embodiment of the disclosure.

FIG. 3 is a schematic diagram of an optical principle of folding the light path in FIG. 2.

FIG. 4 is a schematic diagram of a Fourier 4F optical system according to an embodiment of the disclosure.

FIG. 5 is an image formed on an eye box according to an embodiment of the disclosure.

FIG. 6 is an MTF curve of a mixed reality device according to an embodiment of the disclosure.

FIG. 7A is a field curvature diagram of a mixed reality device according to an embodiment of the disclosure.

FIG. 7B shows a distortion diagram of a mixed reality device according to an embodiment of the disclosure.

### DETAILED DESCRIPTION OF DISCLOSED EMBODIMENTS

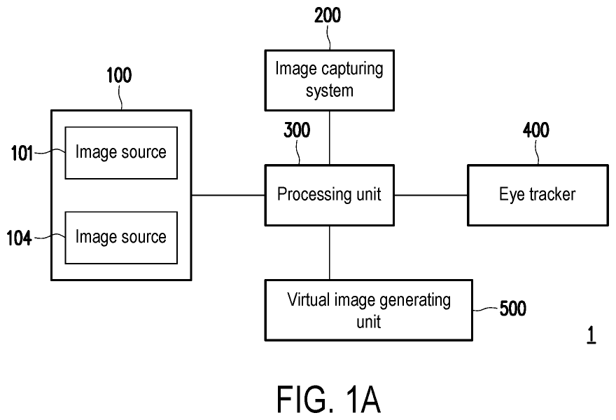

Referring to FIGS. 1A and 1B, a mixed reality device 1 according to an embodiment of the disclosure includes an image system 100, an image capturing system 200, a processing unit 300, an eye tracker 400, and a virtual image generating unit 500. The image system 100, the image capturing system 200, the eye tracker 400, and the virtual image generating unit 500 are respectively connected to the processing unit 300.

The image system 100 includes an image source 101, an image source 104, a beam splitter 102, a lens set 105, and a lens set 103.

The processing unit 300 is, for example, a central processing unit (CPU), a microprocessor, a digital signal processor (DSP), a programmable controller, a programmable logic device (PLD), or other similar devices or a combination of the devices. The disclosure is not limited thereto. In addition, in an embodiment, each of functions of the processing unit 300 may be implemented as multiple program codes. The program codes are stored in a memory and executed by a controller. In addition, in an embodiment, each of the functions of the processing unit 300 may be implemented as one or more circuits. The disclosure is not limited to implementing each of the functions of the processing unit 300 by using software or hardware.

The image capturing system 200 includes an image capturing lens, and the image capturing lens (not shown) is configured to capture an external image outside the mixed reality device 1. The external image is divided into multiple sub-images through the processing unit 300. Each of the sub-images is an image of the external image in different directions and at different distances relative to the image capturing lens (i.e., images of different depths).

The eye tracker 400 is used to track a gaze direction of a user and generate eye tracking information accordingly. The processing unit 300 determines which sub-images among the sub-images to be presented respectively by the image source 101 and the image source 104 of the image system 100 according to the eye tracking information. In some embodiments of the disclosure, the image source 101 and the image source 104 are respectively used to present sub-images of different depths, and the sub-images are respectively imaged on an eye box 107 of the image system 100. The sub-images of different depths show a certain degree of parallax through binocular vision and form a stereoscopic image in a brain. However, the disclosure is not limited thereto.

The virtual image generating unit 500 is used to generate a virtual image. Through the processing unit 300, the virtual image is presented on at least one of the image source 101 and the image source 104, and is imaged on the eye box 107 of the image system 100 for the user to view.

According to some embodiments of the disclosure, the image source 101 is used to present an external sub-image with a larger depth, and the image source 104 is used to present an external sub-image with a smaller depth and the virtual image. In some embodiments, the image source 101 is used to present the external sub-image with the larger depth and the virtual image, and the image source 104 is used to present the external sub-image with the smaller depth.

Next, referring to FIG. 1B, which shows an image system provided according to an embodiment of the disclosure. In the image system 100, the image source 101 provides an image beam 101L, and the image source 104 provides an image beam 104L. In addition, the beam splitter (BS) 102 is disposed on paths of the image beam 101L and the image beam 104L for light combining.

The image source 101 may be, for example, a liquid crystal display or an active organic light emitting diode display, which has high resolution, high refresh rate, and low pixel pitch, allowing human eyes to be immersed in the image when viewing it.

The image source 104 may be a microdisplay, for example, displays with RGB colors and high brightness such as liquid crystal on silicon (LCoS), a micro-OLED, a micro LED, or use a holographic optical element (HOE) as a solution for multiple depth display. In addition, it may also be a laser scanning display or an LED point light source array formed by laser combined with a MENS micro lens reflection array. In some embodiments, the image source 104 is used to display simple numbers, text messages, etc. at different focal lengths (depths). However, the disclosure is not limited thereto.

In some embodiments, in addition to the beam splitter cube, an embedded beam splitter (embedded BS) or a waveguide-like beam splitter (waveguide-like BS) that generates a micro structure through a semiconductor process may also be chosen to reduce a volume occupied by the beam splitter 102 in the image system 100 and improve imaging quality of the image beam 101L and the image beam 104L.

Next, referring to FIGS. 1B, 2, and 3 together, it is understood how to fold a light path using multiple lens elements and optical film layers on different lens elements in the mixed reality device provided according to the embodiment of the disclosure, so as to achieve a purpose of expanding a field of view.

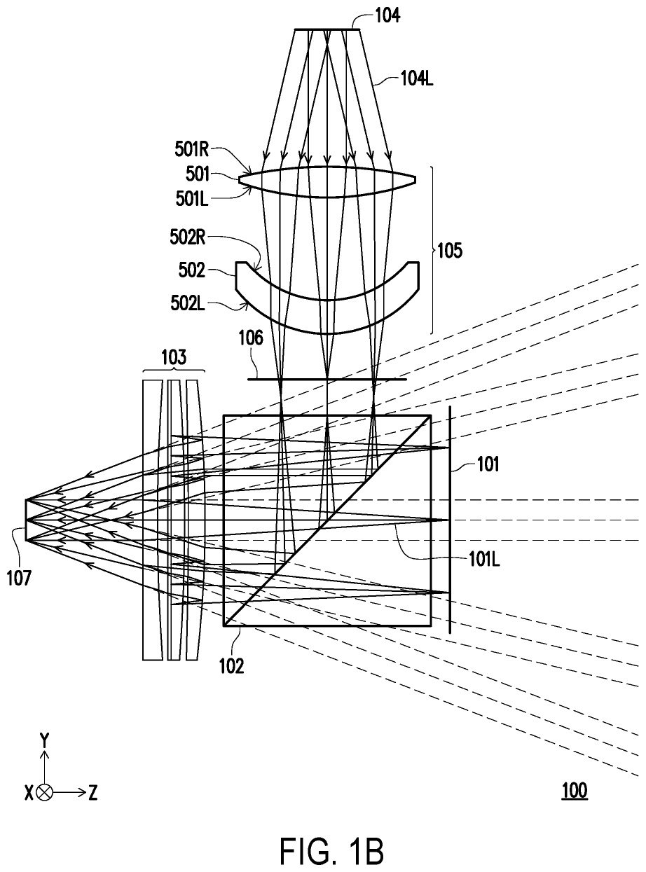

As shown in FIGS. 1B and 2, the image system 100 includes the lens set 103 disposed on a light-exiting side of the beam splitter 102, which is disposed on the paths of the image beam 101L and the image beam 104L, and includes multiple lens elements 201, 202, and 203. The lens elements 201, 202, and 203 are sequentially arranged along a light axis of the lens set 103 from an object-side direction (a +Z direction) of the lens set 103 to an image-side direction (a −Z direction), which have positive diopter, positive diopter, and negative diopter respectively, and are a meniscus lens element, a plano-convex lens element, and a plano-concave lens element respectively. The lens element 201 has an object-side surface 201R and an image-side surface 201L. The lens element 202 has an object-side surface 202R and an image-side surface 202L. The lens element 203 has an object-side surface 203R and an image-side surface 203L.

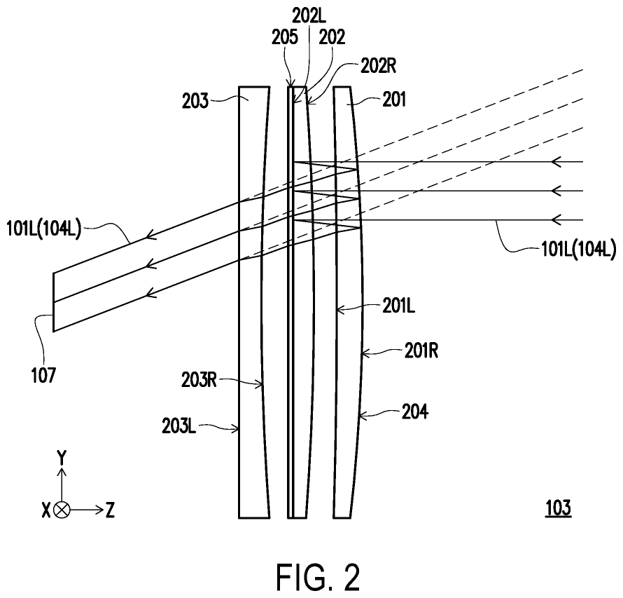

Referring again to FIGS. 2 and 3 together, an optical module 204 is disposed on the object-side surface 201R of the lens element 201. The object-side surface 201R has a curved surface with a concave surface facing the eye box 107. An optical module 205 is disposed on the image-side surface 202L of the lens element 202. The optical module 204 includes a linear polarizer 2041, a quarter-wave plate 2042, and a partial-reflective plate 2043, which are sequentially arranged along the light axis of the lens set 103 from the object-side direction (the +Z direction) of the lens set 103 to the image-side direction (the −Z direction). The optical module 205 includes a quarter-wave plate 2051 and a reflective polarizer 2052, which are sequentially arranged along the light axis of the lens set 103 from the object-side direction (the +Z direction) of the lens set 103 to the image-side direction (the −Z direction). It should be noted that FIG. 3 may be regarded as an exploded view of FIG. 2, used to illustrate changes in a polarization state of light during a process of the image beam 101L and the image beam 104L penetrating through the lens set 103. Since the lens elements 201, 202, and 203 do not change the polarization state of the light, for the convenience of understanding, shapes of the lens elements are not shown in FIG. 3, and only positions thereof are schematically shown.

Referring to FIGS. 1B to 3, after passing through the beam splitter 102, the image beam 101L and the image beam 104L will be reflected by the reflective polarizer 2052, and then penetrate through the quarter-wave plate 2051, the lens element 202, and the lens element 201 in a reverse direction (in the +Z direction) after sequentially penetrating through the linear polarizer 2041, the quarter-wave plate 2042, the partial-reflective plate 2043, the lens element 201, the lens element 202, and the quarter-wave plate 2051 in the −Z direction. At least a part of the image beam 101L and the image beam 104L moves toward the −Z direction after being reflected by the partial-reflective plate 2043, and is imaged on the eye box 107 after sequentially penetrating through the lens element 201, the lens element 202, the quarter-wave plate 2051, the reflective polarizer 2052, and the lens element 203 in the −Z direction.

Specifically, referring to FIG. 3, when the image beam 101L and the image beam 104L penetrate through the linear polarizer 2041 in the −Z direction, electric fields of the image beam 101L and the image beam 104L are formed into linearly polarized light having a polarization direction falling on an X-Y plane and being at an angle of 45 degrees to a Y direction. When the linearly polarized light penetrates through the quarter-wave plate 2042, it forms right-handed circular polarized light. When the right-handed circular polarized light travels in the −Z direction, a part of the light is reflected by the partial-reflective plate 2043 and cause loss, while other part of the light penetrates through the partial-reflective plate 2043 and remains as the right-handed circular polarized light. When the right-handed circular polarized light travels in the −Z direction, it penetrates through the lens element 201 and the lens element 202 sequentially and remain as the right-handed circular polarized light, and after penetrating through the quarter-wave plate 2051, it is formed into the linearly polarized light at the angle of 45 degrees to the Y direction. The linearly polarized light is reflected by the reflective polarizer 2052, which penetrates through the quarter-wave plate 2051 in the +Z direction with a linear polarization state that is also at the angle of 45 degrees to the Y direction to form the right-handed circular polarized light. When the right-handed circular polarized light is on the lens element 202 and the lens element 201, the polarization state thereof is not changed, and after being reflected by the partial-reflective plate 2043, it moves toward the −Z direction as left-handed circular polarized light. The left-handed circular polarized light does not change a polarization state thereof when penetrating through the lens element 201 and the lens element 202, and is formed into the linearly polarized light at an angle of 135 degrees to the Y direction after penetrating through the quarter-wave plate 2051. The linearly polarized light is not subject to the selection of the reflective polarizer 2052 and may penetrate through the reflective polarizer 2052 in the linear polarization state at the angle of 135 degrees to the Y direction, and is imaged on the eye box 107 after penetrating through the lens element 203.

It should be particularly noted that by disposing the optical module 204 on the object-side surface 201R of the lens element 201 and the optical module 205 on the image-side surface 202L of the lens element 202, polarization states of the image beam 101L and the image beam 104L are changed due to the optical film layers, and therefore a situation of moving backward and forward occurs in the lens set 103. Through the above situation of moving backward and forward of the light beam, the field of view may be further changed. More specifically, as shown in FIG. 2, since the object-side surface 201R of the lens element 201 is the curved surface with the concave surface facing the eye box 107, the partial-reflective plate 2043 disposed thereon also has the curved surface with the concave surface facing the eye box 107. Therefore, when the right-handed circular polarized light traveling in the +Z direction is reflected by the partial-reflective plate 2043, the light beam will have a specific traveling direction due to the concave surface facing the eye box 107, so that a field of view after the image beam 101L and the image beam 104L exit the lens set 103 is greater than a field of view before the image beam 101L and the image beam 104L enter the lens set 103. As shown in FIG. 2, an extension line (shown as a dashed line) of the image beam 101L and the image beam 104L exiting the lens set 103 has a greater field of view than the image beam 101L and the image beam 104L entering the lens set 103, thereby expanding a field of view of the mixed reality device 1 accordingly. It should further be noted that through a design of folding the light path in which the image beam 101L and the image beam 104L move backward and forward in the lens set 103, the overall volume of the mixed reality device 1 is reduced, providing a thin, light, and wide field of view mixed reality device 1.

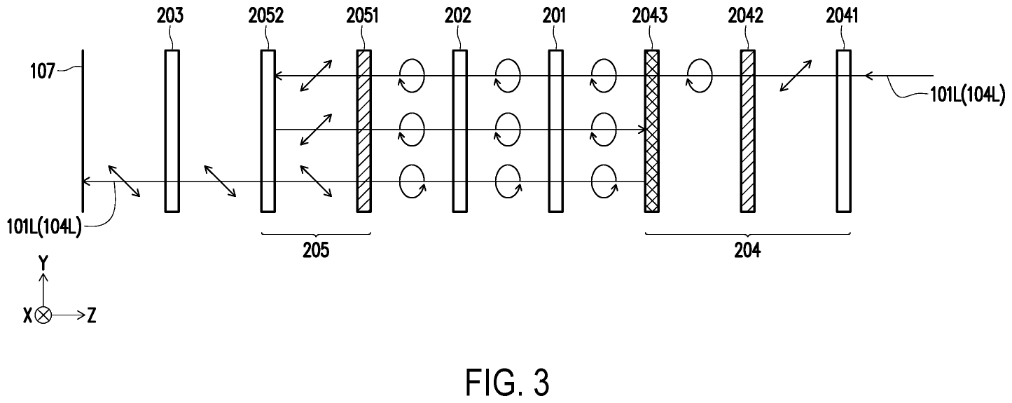

Next, referring to both FIGS. 1B and 4, according to an embodiment of the disclosure, the image system 100 may further include a filter device 106, which may be, for example, a spatial light modulator (SLM) made from a fast-reacting polymer stabilized liquid crystal. When a voltage is applied to the filter device 106, an scattering effect of a polymer liquid crystal therein is reduced, and then a wavelength is modulated while maintaining high transmittance to filter high and low frequency light waves and improve the image quality. In an embodiment, when the image source 104 is the laser scanning display, since it only changes a display position of the light source and may not control an intensity of the image beam 104L, the spatial light modulator 106 will be required to be added to control the intensity and phase of the light to control brightness of the image.

As shown in FIG. 4, in this embodiment, the image source 104, the lens set 105, the filter device 106, the lens set 103, and the eye box 107 are sequentially arranged on the path of the image beam 104L, and form a Fourier 4F optical system. The lens set 105 is a first set of Fourier transform lens elements of a Fourier 4F optical architecture, and the lens set 103 is a second set of Fourier transform lens elements of the Fourier 4F optical architecture. F1 is an equivalent focal length of the lens set 105, and F2 is an equivalent focal length of the lens set 103. Parallel light (the image beam 104L) emitted by the image source 104 is focused on the filter device 106 on a Fourier transform plane, and the filter device 106 is disposed on the Fourier transform plane of the Fourier 4F optical architecture to filter unnecessary frequency spectra to achieve an effect of improving the image quality. By using the Fourier 4F optical architecture, a restored light field that has the same pattern and is inverted as a light field of the image source 104 may be generated in the eye box 107.

In addition, since a magnification of the Fourier 4F optical architecture is a ratio of the equivalent focal length F2 of the lens set 103 to the equivalent focal length F1 of the lens set 105 (i.e., the magnification is −F2/F1), by appropriately designing the equivalent focal length of the lens set 103 and the lens set 105, the light field of the image source 104 may be restored in the eye box 107, and the user may view the image with a magnification or reduction effect.

Referring to FIGS. 1B and 2, according to an embodiment of the disclosure, the lens set 105 includes a lens element 501 and a lens element 502, and both lens elements have positive diopter. The lens element 501 includes an object-side surface 501R and an image-side surface 501L, and the lens element 502 includes an object-side surface 502R and an image-side surface 502L. Optical data of the lens set 103 and the lens set 105 are shown in Table 1.

TABLE 1

| | | Radius of | | |
|---|---|---|---|---|
| | | curvature | | Abbe |
| Element | Surface | mm | Refractivity | number |
| Lens | object-side surface | 124.082 | 1.92 | 20.88 |
| element 201 | 201R | | | |
| | image-side surface | 926.915 | | |
| | 201L | | | |
| Lens | object-side surface | 185.244 | 1.92 | 20.88 |
| element 202 | 202R | | | |
| | image-side surface | infinite | | |
| | 202L | | | |
| Lens | object-side surface | −204.715 | 1.92 | 20.88 |
| element 203 | 203R | | | |
| | image-side surface | infinite | | |
| | 203L | | | |
| Lens | object-side surface | 47.313 | 1.90 | 31.32 |
| element 501 | 501R | | | |
| | image-side surface | −33.705 | | |
| | 501L | | | |
| Lens | object-side surface | −11.693 | 1.62 | 36.35 |
| element 502 | 502R | | | |
| | image-side surface | −12.654 | | |
| | 502L | | | |

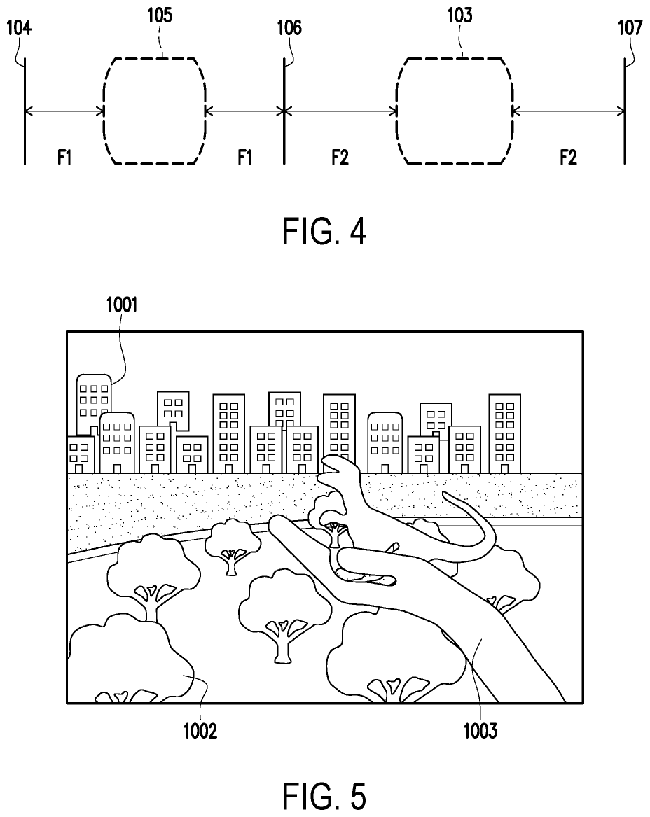

Referring to FIGS. 1A, 1B, and 5 together, FIG. 5 shows an image formed on the eye box according to an embodiment of the disclosure. In this embodiment, the image source 101 is used to present the external sub-image with the larger depth, and the image source 104 is used to present the external sub-image with the smaller depth and the virtual image. Specifically, after passing through the beam splitter 102, the sub-images presented by the image source 101 are converged on the eye box 107 through the lens set 103 to form an image 1001. The sub-images presented by the image source 104 are converged on the eye box 107 through the Fourier 4F optical architecture formed by the lens set 105 and the lens set 103 to form an image 1002 and an image 1003. The image 1001 and the image 1002 are external images outside the mixed reality device 1, and the image 1001 has a greater depth than the image 1002. The image 1003 is a virtual image generated by the virtual image generating unit 500. Accordingly, the external images 1001 and 1002 of different depths and the virtual image 1003 may be converged on the eye box 107 at the same time through optical architectures with different focal lengths, effectively avoiding VAC and providing the user with a comfortable wearing experience.

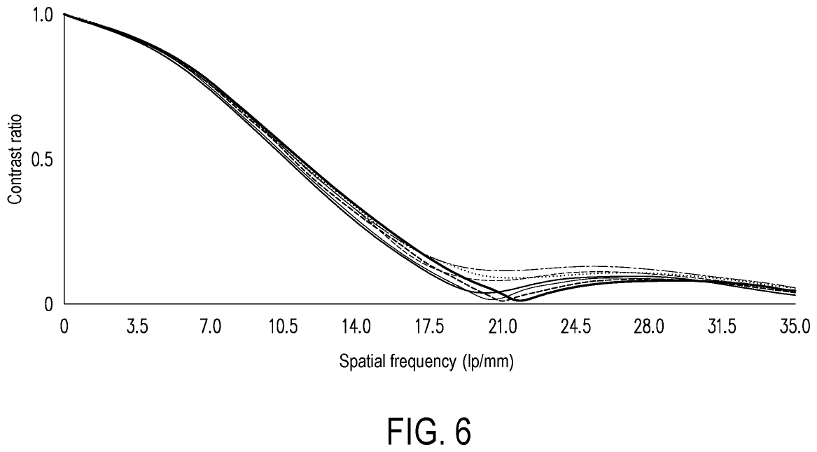

Referring to FIG. 6, FIG. 6 is an MTF curve of a mixed reality device according to an embodiment of the disclosure. When a spatial frequency is 7 lp/mm (an imaging size of an analytical object is about 71.43 m), an MTF thereof still has a performance greater than 0.75. With an acceptable minimum MTF of more than 30%, the mixed reality device according to the embodiment of the disclosure has a resolution of 13.8 lp/mm, and may form a clear image for an object of 36.23 μm.

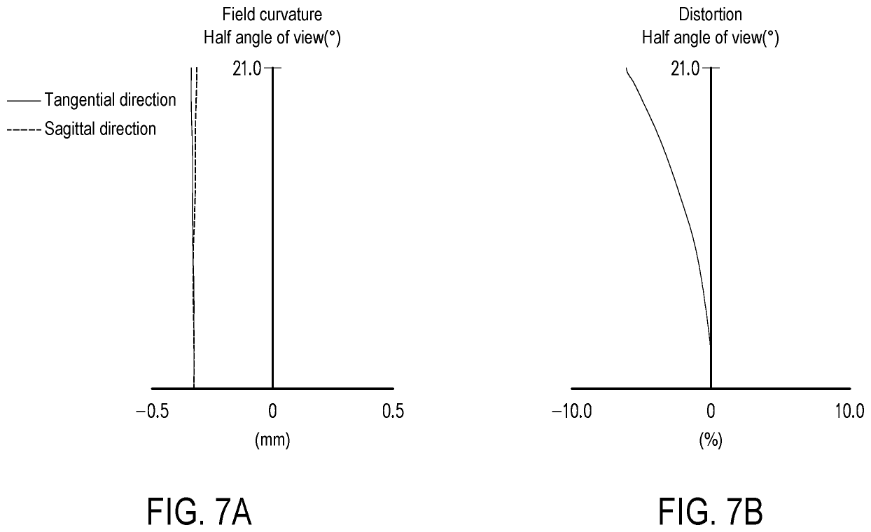

Referring to FIGS. 7A and 7B, FIG. 7A is a field curvature diagram of a mixed reality device according to an embodiment of the disclosure, and FIG. 7B shows a distortion diagram of a mixed reality device according to an embodiment of the disclosure. For color light with a wavelength of 550 nm, a field curvature at different fields of view is within a range of ±0.5 mm. The distortion aberration diagram in FIG. 7B shows that distortion aberration is maintained within a range of ±10%. Although there are offsets and distortions in the field of view, the effects may be corrected through image processing and have little impact on the quality of the image presented to the human eyes.

Based on the above, in the mixed reality device provided according to the embodiments of the disclosure, through the optical architectures with different focal lengths, the images of different depths are converged on the eye box at the same time, providing an effect of stereoscopic vision, effectively avoiding VAC, and providing the user with a comfortable wearing experience.

What is claimed is:

1. A mixed reality device, comprising an image system, wherein the image system comprises:
a first image source configured to provide a first image beam;
a second image source configured to provide a second image beam;
a beam splitter disposed on paths of the first image beam and the second image beam;
a first lens set disposed between the second image source and the beam splitter and comprising at least one lens element;
a second lens set disposed on the paths of the first image beam and the second image beam and comprising a plurality of lens elements,
wherein the first image beam and the second image beam are imaged on an eye box of the mixed reality device after moving backward and forward between the lens elements of the second lens set, and a field of view after the first image beam and the second image beam exit the second lens set is greater than a field of view before the first image beam and the second image beam enter the second lens set.

2. The mixed reality device according to claim 1, wherein the image system further comprises a filter device disposed on the path of the second image beam and located between the first lens set and the second lens set.

3. The mixed reality device according to claim 2, wherein the second image source, the first lens set, the filter device, the second lens set, and the eye box are sequentially arranged on the path of the second image beam, and form a Fourier 4F optical system.

4. The mixed reality device according to claim 3, wherein the filter device is a spatial light modulator disposed on a Fourier transform plane of the Fourier 4F optical system, and comprises a liquid crystal.

5. The mixed reality device according to claim 1, wherein the second lens set further comprises a partial-reflective plate and a reflective polarizer sequentially arranged on the paths of the first image beam and the second image beam, respectively disposed on different lens elements among the lens elements of the second lens set.

6. The mixed reality device according to claim 5, wherein the partial-reflective plate is disposed on a surface of one of the lens elements of the second lens set, and the surface is a curved surface with a concave surface facing the eye box.

7. The mixed reality device according to claim 5, wherein the second lens set further comprises a linear polarizer, a first quarter-wave plate, and a second quarter-wave plate sequentially arranged on the paths of the first image beam and the second image beam and respectively disposed on the lens elements of the second lens set, the first quarter-wave plate is disposed between the linear polarizer and the partial-reflective plate, and the second quarter-wave plate is disposed between the partial-reflective plate and the reflective polarizer.

8. The mixed reality device according to claim 1, further comprising an image capturing system and a processing unit, wherein the image capturing system comprises an image capturing lens and is connected to the processing unit, the image capturing lens is configured to capture an external image outside the mixed reality device, the processing unit is connected to the first image source and the second image source, wherein the first image beam and the second image beam respectively correspond to images of different depths of the external image.

9. The mixed reality device according to claim 8, further comprising an eye tracker connected to the processing unit, wherein the processing unit determines the first image beam and the second image beam provided by the first image source and the second image source according to eye tracking information generated by the eye tracker.

10. The mixed reality device according to claim 8, further comprising a virtual image generating unit, wherein the virtual image generating unit is connected to the processing unit and configured to generate a virtual image, wherein the virtual image is presented through at least one of the first image source and the second image source.

11. The mixed reality device according to claim 1, wherein the second lens set comprises a total of three lens elements with diopter.

12. The mixed reality device according to claim 1, wherein the second lens set comprises a plano-convex lens element and a plano-concave lens element.

13. The mixed reality device according to claim 1, wherein when the first image beam and the second image beam move backward and forward between the lens elements of the second lens set, the first image beam and the second image beam are converted between linear polarized light and circular polarized light.
